(19) United States
(12) Patent Application Publication
(10) Pub. No.: US 2026/0370563 A1
(43) Pub. Date: Nov. 19, 2026

(54) METHODS AND APPARATUS FOR SUPPORTING AI/ML MODEL LIFE CYCLE MANAGEMENT IN WIRELESS COMMUNICATION NETWORKS

(71) Applicant: Samsung Electronics Co., Ltd., Suwon-si, Gyeonggi-do (KR)

(72) Inventors: Chadi KHIRALLAH, Staines (GB); Ezeddin Al HAKIM, Staines (GB); Mahmoud WATFA, Staines (GB)

(21) Appl. No.: 19/137,866

(22) PCT Filed: Nov. 30, 2023
(86) PCT No.: PCT/KR2023/019572

§ 371 Date: Jun. 11, 2025

(30) Foreign Application Priority Data
Dec. 13, 2022 (GB) 2218785.0
Oct. 6, 2023 (GB) 2315335.6

(51) Int. Cl. H04L 41/16; H04L 41/082; H04W 24/02

(52) U.S. Cl. CPC H04L 41/16; H04L 41/082; H04W 24/02

(57) ABSTRACT

The disclosure relates to a 5G or 6G communication system for supporting a higher data transmission rate. A method for artificial intelligence/machine learning (AI/ML) model/functionality life cycle management (LCM) by a management entity in a mobile communications network, the method comprising: receiving, from a first entity, a request to register an AI/ML model/functionality, the request including metadata related to the AI/ML model/functionality; assigning an identifier (ID) to the AI/ML model/functionality; and storing information on the AI/ML model/functionality and the related metadata.

### TECHNICAL FIELD

Certain examples of the present disclosure provide one or more techniques for supporting Artificial Intelligence/Machine Learning (AI/ML) model life cycle management in wireless communication networks. For example, certain examples of the present disclosure provide one or more techniques for registering, selecting, updating, configuring, and subscribing to AI/ML models in 3^{rd} Generation Partnership Project (3GPP) 5G or 6G networks.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AT-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

### Solution to Problem

In accordance with a first aspect of the present disclosure, there is a provided method for artificial intelligence/machine learning (AI/ML) model/functionality life cycle management (LCM) by a management entity in a mobile communications network, the method comprising: receiving, from a first entity, a request to register an AI/ML model/functionality, the request including metadata related to the AI/ML model/functionality; assigning an identifier (ID) to the AI/ML model/functionality; and storing information on the AI/ML model/functionality and the related metadata

In an example, the metadata related to the AI/ML model/functionality includes information on one or more of a performance indicator, a use-case, a model/functionality input, a model/functionality output, accuracy metrics, a number of layers, a number of parameters, a model/functionality format, a model/functionality scenario, a model/functionality site, version number, model deployment side, model training side, model inference side, model training online or offline, model training type, model size, model format, performance metrics, single or multiple functionality model, and open or proprietary-format model.

In an example, the ID includes at least one of a global model ID, a local model ID, a global functionality ID, and a local functionality ID.

In an example, the stored information on the AI/ML model/functionality includes information on one or more of model/functionality ID, model architecture, model weights, validity, registration time, and registration location.

In an example, the storing comprises storing the information on the AI/ML model/functionality and the related metadata in a model/functionality template or profile.

In an example, the method further comprises transmitting, to the first entity, a response to the request to register an AI/ML model/functionality indicating a success or a failure of the request to register an AI/ML model/functionality.

In an example, if the assigning and storing are successful, the response indicates that the request to register an AI/ML model/functionality has been successful.

In an example, if the assigning or storing are unsuccessful, the response indicates that the request to register an AI/ML model/functionality has failed.

In an example, the response that indicates that the request to register an AI/ML model/functionality has failed includes an indication of a failure cause, the failure cause including one or more of registration not supported or registration not accepted.

In an example, the storing includes storing the AI/ML model/functionality.

In an example, the method further comprises receiving, from the first entity, an update message for the AI/ML model/functionality and updating the AI/ML model/functionality based on the update message.

In an example, the method further comprises transmitting, to the first entity, a response to the update message indicating a success or a failure of the updating of the AI/ML model/functionality.

In an example, if the update of the AI/ML model/functionality is successful, the response to the update message indicates that the update of the AI/ML model/functionality has been successful.

In an example, if the update of the AI/ML model/functionality is unsuccessful, the response to the update message indicates that the update of the AI/ML model/functionality has been unsuccessful.

In an example, the response that indicates that the request to update the AI/ML model/functionality is unsuccessful includes an indication of a failure cause, the failure cause including one or more of update is not allowed, update is not supported, and the model/functionality is not supported.

In an example, the method further comprises: receiving, from the first entity, an AI/ML model/functionality selection request including selection information; identifying a registered AI/ML model/functionality based on the selection information; and transmitting, to the first entity, an AI/ML model/functionality selection response including information on the identified AI/ML model/functionality.

In an example, the information on the identified AI/ML model/functionality includes one or more of an ID of the identified AI/ML model/functionality, a profile of the identified AI/ML model/functionality, and a validation value of the identified AI/ML model/functionality.

In an example, the selection request includes one or more of an AI/ML model/functionality description, an AI/ML model/functionality ID, a validation criteria, an AI/ML model/functionality type, an AI/ML model/functionality training type, an AI/ML model/functionality deployment type, and an aggregate evaluation function.

In an example, the management entity is an AI/ML model/functionality LCM entity.

In an example, the first entity is a client entity, a network entity (e.g. RAN, CN, other internal/external entity), a network function, a UE, a server, an OAM, and/or an AF.

In an example, the management entity is implemented in one or more of a client entity, a network entity (e.g. RAN, CN, other internal/external entity), a network function, a UE, a server, an OAM, and/or an AF.

In an example, the artificial intelligence/machine learning (AI/ML) model/functionality life cycle management (LCM) is model-based or functionality-based.

In accordance with a second aspect of the present disclosure, there is provided a management entity for artificial intelligence/machine learning (AI/ML) model/functionality life cycle management (LCM) in a mobile communications network, the management entity configured to: receive, from a first entity, a request to register an AI/ML model/functionality, the request including metadata related to the AI/ML model/functionality; assign an identifier (ID) to the AI/ML model/functionality; and store information on the AI/ML model/functionality and the related metadata.

Other aspects, advantages and salient features of the invention will become apparent to those skilled in the art from the following detailed description taken in conjunction with the accompanying drawings.

### Advantageous Effects of Invention

Embodiments of the present disclosure provides methods and apparatus for AI/ML model/functionality lifecycle management including registration, selection and update of model or functionality.

### BRIEF DESCRIPTION OF DRAWINGS

FIG. 1 provides an overview of MLOps processes for end-to-end lifecycle management.

FIG. 2 provides an example of a new model/functionality registration procedure (Class 1) for a successful operation in accordance with the present disclosure.

FIG. 3 provides an example of a new model/functionality registration procedure (Class 1) for an unsuccessful operation in accordance with the present disclosure.

FIG. 4 provides an example of a new model or functionality registration procedure (Class 2) in accordance with the present disclosure.

FIG. 5 provides an example of a new model/functionality update procedure for a successful operation in accordance with the present disclosure.

FIG. 6 provides an example of a new model/functionality update procedure for an unsuccessful operation in accordance with the present disclosure.

FIG. 7 provides an example of a new model/functionality update procedure (Class 2) in accordance with the present disclosure.

FIG. 8 provides an example of a new model/functionality update procedure for a successful operation in accordance with the present disclosure.

FIG. 9 provides an example of a new model/functionality modify procedure for a successful operation in accordance with the present disclosure.

FIG. 10 provides an example of a new model/functionality selection procedure for a successful operation in accordance with the present disclosure.

FIG. 11 provides an example of model/functionality selection procedure for an unsuccessful operation in accordance with the present disclosure.

FIG. 12 is a block diagram of an exemplary entity that may be used in certain examples of the present disclosure.

### MODE FOR THE INVENTION

The following description of examples of the present disclosure, with reference to the accompanying drawings, is provided to assist in a comprehensive understanding of the present invention. The description includes various specific details to assist in that understanding but these are to be regarded as merely exemplary. Accordingly, those of ordinary skill in the art will recognize that various changes and modifications of the examples described herein can be made without departing from the scope of the invention.

The same or similar components may be designated by the same or similar reference numerals, although they may be illustrated in different drawings.

Detailed descriptions of techniques, structures, functions, operations or processes known in the art may be omitted for clarity and conciseness, and to avoid obscuring the subject matter of the present invention.

The terms and words used herein are not limited to the bibliographical or standard meanings, but, are merely used to enable a clear and consistent understanding of the invention.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description and claims of this specification, the singular form, for example “a”, “an” and “the”, encompasses the plural unless the context otherwise requires. For example, reference to “an object” includes reference to one or more of such objects.

Throughout the description and claims of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment, example or claim are to be understood to be applicable to any other aspect, embodiment, example or claim described herein unless in-compatible therewith.

The skilled person will appreciate that the techniques described herein may be used in any suitable combination.

Certain examples of the present disclosure provide one or more techniques for managing AI/ML models in wireless communications networks. For example, certain examples of the present disclosure provide one or more techniques for managing AI/ML models in a 3GPP 5G and 6G networks. However, the skilled person will appreciate that the present invention is not limited to these examples, and may be applied in any suitable system or standard, for example one or more existing and/or future generation wireless communication systems or standards, including any existing or future releases of the same standards specification.

The functionality of the various network entities and other features disclosed herein may be applied to corresponding or equivalent entities or features in the same or any other suitable communication systems or standards. Corresponding or equivalent entities or features may be regarded as entities or features that perform the same or similar role, function or purpose within the network or external to the network.

A particular entity may be implemented as a network element on a dedicated hardware, as a software instance running on a dedicated hardware, and/or as a virtualised function instantiated on an appropriate platform, e.g. on a cloud infrastructure.

The skilled person will appreciate that the present invention is not limited to the specific examples disclosed herein. For example:
The techniques disclosed herein are not limited to 3GPP 5G and 6G.
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements or entities may be added to the examples disclosed herein.
One or more non-essential elements or entities may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed and/or the order in which messages are transmitted may be modified, if possible, in alternative examples.

The present disclosure introduces a new entity/function that is located internal or external to the network and/or UE(s) and/or server or Application Function (AF). The proposed entity will handle/manage various model LCM procedures in wireless networks. The new entity, may be termed, for example, Model Learning Controller (MLC), an AI/ML model coordinating entity, AI/ML [model] manager, AI/ML controller, or any other suitable term.

The proposed entity could be included in (or part of) any network entity/function (internal or external), and/or UE(s), and/or server, and/or AF. For example, the MLC could be part of RAN, CN (e.g. AMF, SMF, UPF, UDM, and/or any other internal or external Network entity/function) or OTT server. The functionality may also be distributed in some examples.

In the following sections we describe the solutions and methods for AI/ML model LCM by the proposed new entity MLC, for example, MLC handles the AI/ML model registration, model subscription, model selection, model update, model configuration, in addition to model transfer/delivery between the network entities/functions and/or UE(s).

### ABBREVIATIONS/DEFINITIONS

In the present disclosure, the following acronyms/definitions are used.
3GPP 3^{rd} Generation Partnership Project
5G 5th Generation
6G 6th Generation
AI Artificial Intelligence
AMF Access and Mobility management Function
AS Access Stratum
CFRA Contention Free Random Access
eMTC enhanced Machine Type Communication
eNB Base Station
EPC Evolved Packet Core
E-UTRAN Evolved Universal Terrestrial Radio Access Network
GEO Geosynchronous Equatorial Orbit
gNB 5G Base Station
HAPS High Altitude Platform Station
ID Identity/Identification
IE Information Element
IMEISV International Mobile station Equipment Identity and Software Version
IoT Internet of Things
LCM Life Cycle Management
LEO Lower Earth Orbit
LTE Long Term Evolution
LTE-M LTE Machine Type Communication
MAC Medium Access Control
MDT Minimisation of Drive Test
ML Machine Learning
MLC Model Learning Controller
MME Mobility Management Entity
NB Narrow Band
NG Next Generation
NR New Radio
NTN Non-Terrestrial Network
PCI Physical Cell ID
PLMN Public Land Mobile Network
ProSe Proximity-based Services
RAN Radio Access Network
RAT Radio Access Technology
RLF Radio Link Failure
c-RNTI Cell Radio Network Temporary Identifier
RRC Radio Resource Control
RRM Radio Resource Management
S-GW Serving Gateway
SMF Session Management Function
SRVCC Single Radio Voice Call Continuity
TS Technical Specification
UE User Equipment
UPF User Plane Function
V2X Vehicle to Everything
X2/Xn Interface between RAN nodes

### 3GPP Background

3GPP working groups are studying Artificial Intelligence/Machine Learning (AI/ML) and its use in 3GPP systems. Among others, 3GPP agreed “Study on Artificial Intelligence (AI)/Machine Learning (ML) for NR Air Interface” [2]. This included studying the 3GPP framework for AI/ML for air-interface corresponding to each target use case regarding aspects such as performance, complexity, and potential specification impact.
Initial set of use cases includes: CSI feedback enhancement, Beam management and Positioning accuracy enhancements.
Protocol aspects, related to, e.g., capability indication, configuration and control procedures (training/inference), and management of data and AI/ML model. In addition to, collaboration level specific specification impact per use case.

### RAN1 #109-e Meeting (Selected Agreements)

Take the following network-UE collaboration levels as one aspect for defining collaboration levels
1. Level x: No collaboration
2. Level y: Signaling-based collaboration without model transfer
3. Level z: Signaling-based collaboration with model transfer

Note: Other aspect(s), for defining collaboration levels is not precluded and will be discussed in later meetings, e.g., with/without model updating, to support training/inference, for defining collaboration levels will be discussed in later meetings

For Further Study (FFS): Clarification is needed for Level x-y boundary

### RAN1 #110-e Meeting (Selected Agreements)

Study the following aspects, including the definition of components (if needed) and necessity, in Life Cycle Management
Data collection
   Note: This also includes associated assistance information, if applicable.
Model training

### [Model Registration]

Model deployment
   Note: Terminology is to be defined.

### [Model Configuration]

Model inference operation
Model selection, activation, deactivation, switching, and fallback operation
Model monitoring
Model update
   Note: Terminology is to be defined. This includes model fine tuning, retraining, and re-development via online/offline training.
Model transfer
UE capability

### RAN1 #110b-e Meeting (Selected Agreements):

Study LCM procedure on the basis that an AI/ML model has a model ID with associated information and/or model functionality at least for some AI/ML operations
FFS: Detailed discussion of model ID with associated information and/or model functionality.
FFS: usage of model ID with associated information and/or model functionality based LCM procedure
FFS: whether support of model ID
FFS: the detailed applicable AI/ML operations

For model selection, activation, deactivation, switching, and fallback at least for UE sided models and two-sided models, study the following mechanisms:
Decision by the network
   Network-initiated
   UE-initiated, requested to the network
Decision by the UE
   Event-triggered as configured by the network, UE's decision is reported to network
   UE-autonomous, UE's decision is reported to the network
   UE-autonomous, UE's decision is not reported to the network
FFS: for network sided models
FFS: other mechanisms

Data collection may be performed for different purposes in LCM, e.g., model training, model inference, model monitoring, model selection, model update, etc. each may be done with different requirements and potential specification impact.
FFS: Model selection refers to the selection of an AI/ML model among models for the same functionality. (Exact terminology to be discussed/defined)

Study potential specification impact needed to enable the development of a set of specific models, e.g., scenario-/configuration-specific and site-specific models, as compared to unified models.

Note: User data privacy needs to be preserved. The provision of assistance information may need to consider feasibility of disclosing proprietary information to the other side.

Study the specification impact to support multiple AI models for the same functionality, at least including the following aspects:
Procedure and assistance signaling for the AI model switching and/or selection
FFS: Model selection refers to the selection of an AI/ML model among models for the same functionality. (Exact terminology to be discussed/defined)

Study AI/ML model monitoring for at least the following purposes: model activation, deactivation, selection, switching, fallback, and update (including re-training).
FFS: Model selection refers to the selection of an AI/ML model among models for the same functionality. (Exact terminology to be discussed/defined)

### RAN1 #111-e Meeting (Selected Agreements):

Including characterization of defining stages of AI/ML algorithm and associated complexity, UE-gNB collaboration, life cycle management, dataset(s), and notation/terminology. Also including any common aspects of evaluation methodology.

For UE-part/UE-side models, study the following mechanisms for LCM procedures:
For functionality-based LCM procedure: indication of activation/deactivation/switching/fallback based on individual AI/ML functionality
   Note: UE may have one AI/ML model for the functionality, or UE may have multiple AI/ML models for the functionality.
   FFS: Whether or how to indicate Functionality
For model-ID-based LCM procedure, indication of model selection/activation/deactivation/switching/fallback based on individual model IDs

### Working Assumptions

TABLE 1

| Terminology | Description |
|---|---|
| Model | A process/method of identifying an AI/ML model for the |
| identification | common understanding between the NW and the UENote: |
| | The process/method of model identification may or may |
| | not be applicable. |
| | Note: Information regarding the AI/ML model may be |
| | shared during model identification. |

TABLE 2

| Terminology | Description |
|---|---|
| Functionality | A process/method of identifying an AI/ML functionality |
| identification | for the common understanding between the NW and the |
| | UENote: Information regarding the AI/ML functionality |
| | may be shared during functionality identification. |
| | FFS: granularity of functionality |

Note:
whether and how to indicate Functionality will be discussed separately.

TABLE 3

| Terminology | Description |
|---|---|
| Model update | Process of updating the model parameters and/or |
| | model structure of a model |
| Model parameter | Process of updating the model parameters of a model |
| update | |

### AI/ML Background

### Machine Learning Operations (MLOps)

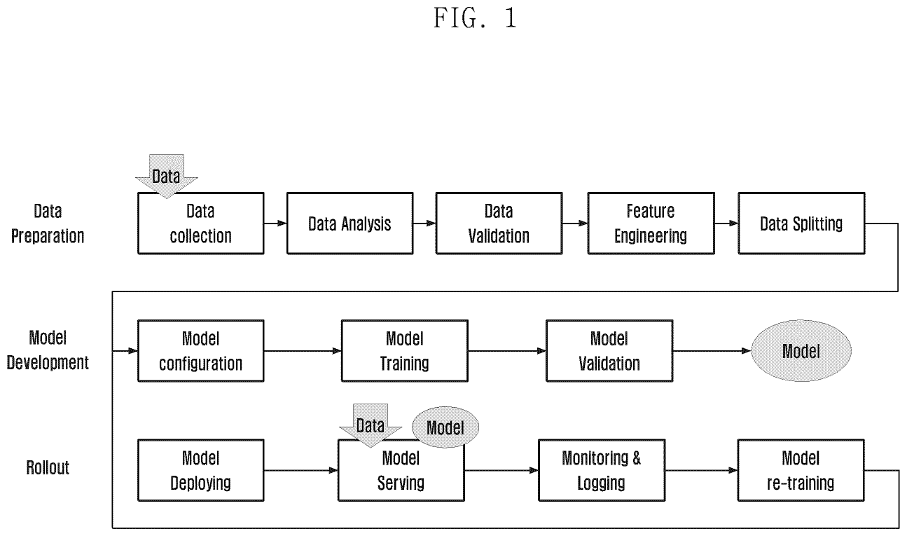

MLOps is a system of processes for the end-to-end AI/ML lifecycle management at scale. These processes ensure that a model can be scaled for a large user base and perform accurately. The MLOps processes can be split into three categories [9], as shown in FIG. 1.

### Data Preparation

This category involves data collection, data analysis, data validation, feature engineering and data splitting. The data is prepared for an AI/ML task, where it applies data pre-processing and feature engineering and split the data into training, validation, and test datasets to solves a target task.

### Model Development

This category involves model configuration, model training and model validation. The data scientist implements different algorithms with the prepared data to train various ML models. In addition, you subject the implemented algorithms to hyper-parameter tuning to get the best performing ML model. The output of this step is a trained model. Next step to validate model to be deployed in the production environment.

### Rollout

This category involves model deploying, model serving, model monitoring and model re-training. The validated model is deployed to a production environment to serve predictions. The model deployment can be REST API micro service to serve online predictions or an embedded model to an edge or mobile device. The model predictive performance is monitored to potentially invoke a new iteration in the ML process.

In view of the background information provided above, the AI/ML model exchange between the network and the UE could be needed, for example, based on:
1) The collaboration level between the network and UE on AI/ML operation, for example, in collaboration Level z may require model transfer between the network and UE to support inference and/or training at the network and/or the UE.
2) The model use case or model functionality, for example, the model is used for one functionality or multiple models are used for the same functionality. Moreover, whether the models are scenario-, site-, or configuration-specific. This could mean the need to exchange the model several times between the network and the UE.
3) The model lifecycle (LCM) management procedures, for example, model training, update, and fine-tuning, re-training, other LCM procedures. For example, model transfer during model training, e.g. joint training in the case of two-sided model training (between the UE and the network).

However, model transfer/delivery and model LCM procedures may result in increased signaling overhead, power consumption and resource usage due to introducing and handling AI/ML related operations in wireless networks.

To this end, the present disclosure provides solutions to introduce AI/ML operations into wireless networks and address these challenges related to AI/ML model lifecycle management. For example, the following aspects are considered in this disclosure:

How to register, select, update, subscribe and configure models and/or model functionality?
How to save the trained models?
What information need to be saved together with the trained model?
How to find/select the best trained model?
How to transfer one or more AI/ML models for the same or different functionality/use case/scenario/site/configuration?
Introducing the new concept of model profile and/or model functionality profile in UE and network exchange during LCM procedures?

The above information is presented as background information only to assist with an understanding of the present disclosure. No determination has been made, and no assertion is made, as to whether any of the above might be applicable as prior art with regard to the present invention.

### AI/ML Model LCM

The following provides a description of different model LCM procedures (e.g. Registration, Update, Selection, Subscription, Configuration, other).

The five stages discussed below are:
1) Model Registration
2) Model Update
3) Model Selection
4) Model Subscription
5) Model Configuration

The following should be taken into account when considering the proposals, examples and methods described in this disclosure:
1) Although the description in this disclosure focusses on the above 5 procedures/stages of model LCM, the proposed solutions, examples, and figures, may be extended and/or modified to include other stages of AI/ML model LCM procedures and/or model transfer or delivery.
2) The execution of the following described LCM stages/procedures can be in any order.
3) The terms functionality/use-case/configuration/scenario/site may be used interchangeably.
4) For simplicity “model functionality” may be referred to/mentioned in the text as “functionality”.
5) All proposals, examples, and/or Figures may apply to model, model functionality and/or functionality.
6) All figures naming including messages and/or signalling can be expressed using the term “Model” or “Functionality” throughout all this invention.
7) The proposed approaches may also apply for the gNB, NG-RAN case and all related RRC signaling and/or messages, and X2, Xn, S1, NG, F1, E1, and/or other in-terfaces signaling and message, and/or other related network entities (e.g. MME, UPF, SMF, AMF, other), in addition to possible interaction with NWDAF (for analytics and predictions purposes).
8) All proposals, examples, and/or Figures may use, existing and/or new signalling/messaging/IEs/procedures (e.g. RRC/NAS, NG, S1, Xn, X2, F1, E1, system information (periodic and/or on-demand), and/or other type of signalling between any network entity/function and the UE(s).
9) The proposed approaches also apply to non-3GPP entities.
10) For simplicity, in the description below, the term “Client” is used to refer to any network entity (RAN, CN, other internal/external entity or function), UE, server, or AF.
11) The concepts, proposals, solutions, methods, and/or examples, presented in this disclosure, apply to various type of communication systems, such as 4G, 4G-Advanced, 5G, 5G-Advanced, and 6G. Moreover, the above may also apply (in full or part or modified) to systems of Non-Terrestrial Networks (NR-NTN and/or IoT-NTN), in addition to Terrestrial Networks (TN).
12) Although the examples set out below focus on the use of an MLC or other form of AI/ML coordinating entity, the disclosure is not so limited and may apply to general AI/ML model handling in wireless communication networks without the introduction of a new entity, whereby the disclosed functionality if implemented in one or more existing entities.

### Model Registration

Step 1: The client triggers the model (or functionality) registration procedure for an AT/ML model for given/specific functionality(s) (or use case(s)/scenario(s)/configuration(s)/site(s)) by sending a model registration request message, including one or more of any available assistance information related to the model (e.g. model functionality/use-case/scenario/site, version number, model deployment side, model training side, model inference side, model training online or offline, model training type, model size, model format, number of parameters, model input/output, accuracy metrics, performance metrics, KPIs, single or multiple functionality model, open- or proprietary-format model, number of layers, other).
Step 2a: the MLC assigns a model ID (local ID or global ID or temporary ID) and/or functionality ID (local ID or global ID or temporary ID) for the registered model and stores this model and/or model information (e.g. in the MLC database). In another example, the MLC may identify the model in relation to its specific functionality (or use-case/scenario/configuration/site information).
Step 2b: the MLC may store information on one or more of the model architecture, weights and metadata (and other model related information) and/or other information related to the model (e.g. received in the client model registration request) into a model template (e.g. namely, Model Profile (MP)) and/or a functionality template (e.g. namely, Functionality Profile (FP)). Also, additionally, the MLC may store the model and/or model information with time and location information (e.g. time and/or location of model registration request, validity of time and/or location of stored or registered model and/or model information).
Step 3: the MLC acknowledges the model registration success or model registration failure to the client. Additionally, the MLC may provide assistance information related to the registered model/functionality (e.g. validity information on usage of the model/functionality and model/functionality information).

In an example, the model registration procedure may be defined as a new class 1 procedure, using new and/or existing messages and/or IEs, or may be defined using existing class 1 procedures, using new and/or existing messages and/or IEs. In one example, the model registration procedure maybe triggered based on a client request and the registration request (success) is acknowledged by the registration entity.

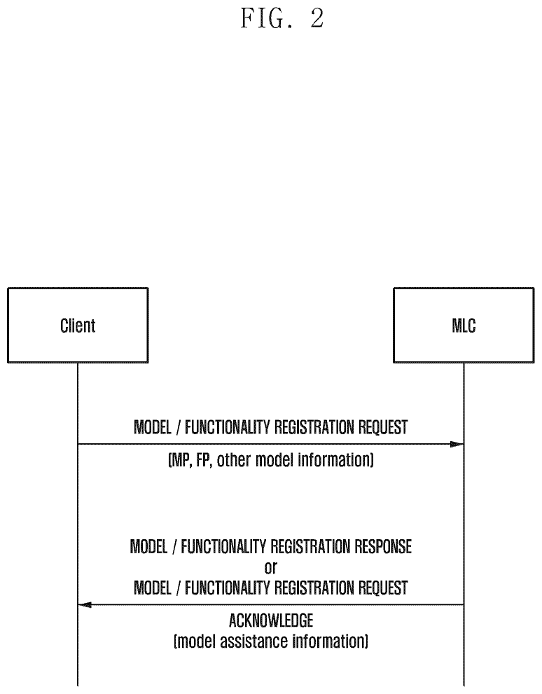

FIG. 2 shows an example of a new class 1. Model Registration (or Functionality Registration) procedure, in which a Client sends a MODEL/FUNCTIONALITY REGISTRATION REQUEST message, including information on Model Profile (MP) and/or Functionality (FP) and/or other information related to the model and/or functionality registration request. In turn, the MLC may acknowledge a successful model (and/or functionality) registration, for example, as shown in steps above (i.e. Step 1, Step 2a, 2b, and Step3). The MLC responds to the client request using, for example, namely MODEL/FUNCTIONALITY REGISTRATION RESPONSE or MODEL/FUNCTIONALITY REGISTRATION REQUEST ACKNOWLEDGE message. Additionally, the MLC may provide assistance information related to the registered model and/or functionality.

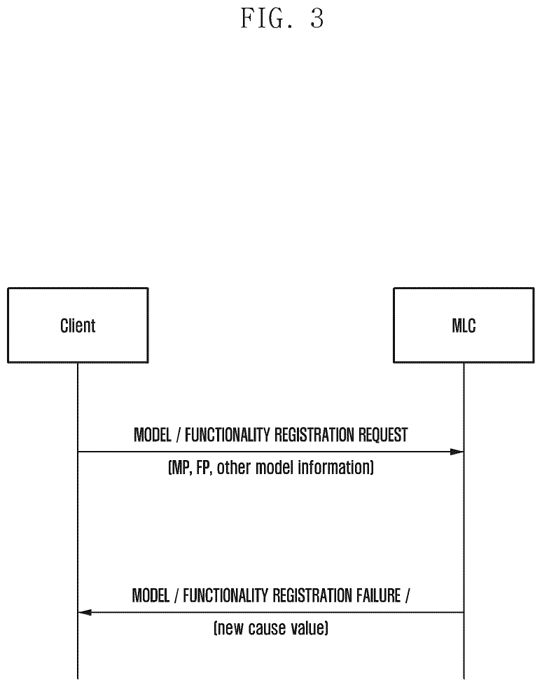

In FIG. 2 and also FIGS. 3, 4, 7, 8, 10, and 11, the bracketed annotations are providing examples of the content of these messages such that the messages are not limited to such content. For example, the messages may include none, some or all of the example content and/or additional content described in the relevant portions of the detailed description.

In another example, the Client may perform a new class 1. Functionality Registration Procedure, in which functionality is defined in relation to a given model or multiple models, or as a generic functionality or as functionality(s) defined separately to a model(s). For example, FUNCTIONALITY REGISTRATION REQUEST/RESPONSE or FUNCTIONALITY REGISTRATION REQUEST ACKNOWLEDGE messages, see example in FIG. 3.

In another example, the model (or functionality) registration procedure may be defined as a new class 1 procedure, using new and/or existing messages and/or IEs, or defined using existing class 1 procedures, using new and/or existing messages and/or IEs. In an example, the model registration procedure (or functionality registration procedure) may be triggered based on a client request and the registration request failure maybe acknowledged to this client by the registration entity.

In an example, the model/functionality registration entity may reply to the client model registration request with a model/functionality registration failure and optionally may indicate to the client the failure reason/cause, using a newly defined appropriate cause value, for example, Cause IE “Registration not supported”, “Registration not accepted”, or any other suitable naming.

In an example, the model/functionality registration entity (e.g. MLC) may reject model/functionality registration request based on information (e.g. subscription information) received from the UDM, or another network entity/function, and/or server or via AF or OAM.

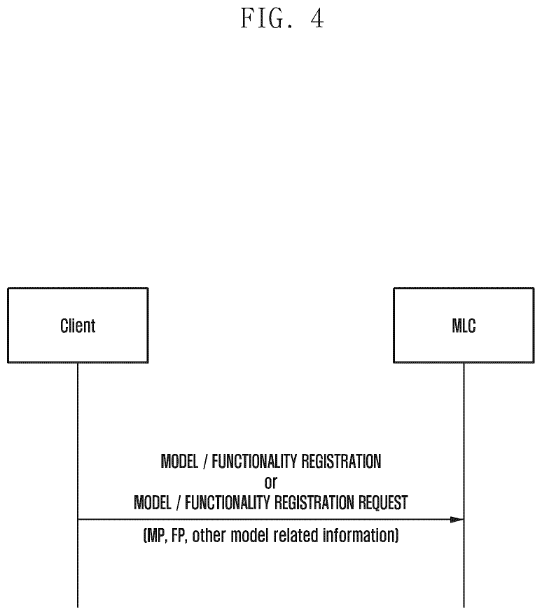

In alternative example, the model or functionality registration procedure may be defined as a new class 2 procedure, using new and/or existing messages and/or IEs, or defined using existing class 2 procedures, using new and/or existing messages and/or IEs. In an example, the model or functionality registration procedure maybe triggered based on a client request and/or other assistance information from the network. See example in FIG. 4.

In one example, a model may be registered together with/for a given functionality/scenario/use-case/configuration/site or together with/for multiple functionalities/use-cases/scenarios/sites/configurations.

In another alternative example, a functionality may be registered together with/for a given model or multiple models. In other way, a functionality maybe registered for use with one model or multiple models.

All proposals and/or examples, messages/procedures labelled in Figures may be expressed in the term “Model” or “Functionality” interchangeably throughout all this invention. Furthermore, the labelling of the messages may also change although their content may be the same or similar.

Note that other steps, sub-steps, or combined steps are also possible as part of the above example on Model Registration, but not shown/described above for simplicity.

### Model Update

Step 1: The Client initiates the AI/ML model update procedure by sending, for example, a MODEL/FUNCTIONALITY UPDATE message. This message may include information on updated MP(s) or FP(s) or any model related information.

If supported, the MLC may update the stored model information, using the received updated MP(s) and/or FP(s) information (e.g. information provided under lists of MP(s) and/or FP(s)). That is, the MLC may store the MP(s) and/or FP(s) information or update it if already stored.

In an alternative, the MLC may ignore any update to the AI/ML model if not meeting a pre-defined criteria and/or conditions (e.g. MP(s) and/or FP(s) version is/are not valid or outdated).

In an alternative, the MLC may update all or part of the stored model information.
Step 2: The MLC may reply to client, for example, by sending a MODEL/FUNCTIONALITY UPDATE ACKNOWLEDGE message to acknowledge that it has successfully updated the model and/or model information. Additionally, the MLC may provide information on whether all or part of model information is updated and/or any information related to the update model. For example, MLC may indicate to the client that only information related to a given functionality/use case/scenario/configuration is updated.

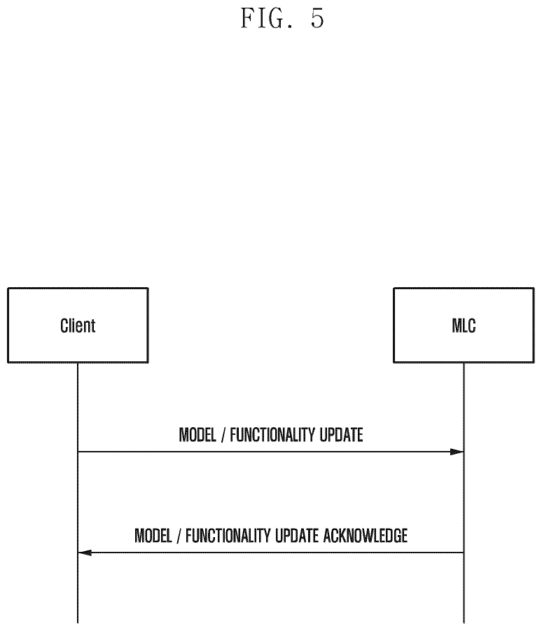

FIG. 5 shows an example of a new model/functionality update procedure described in above steps.

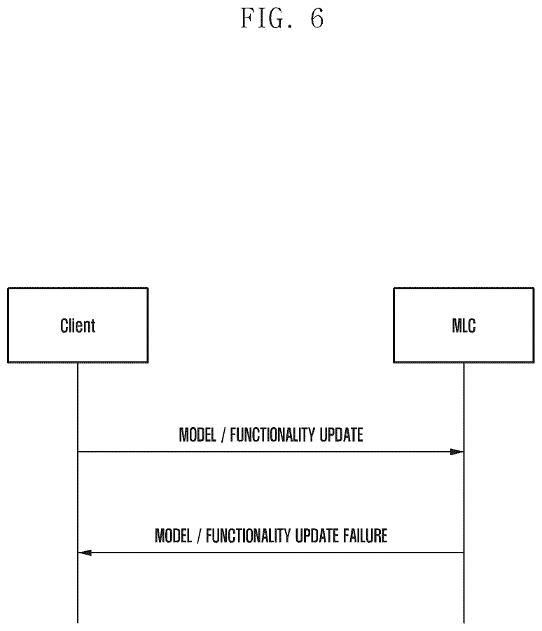

In an example, the MLC may not accept the model update, fully or partially, and may respond, for example, with a MODEL/FUNCTIONALITY UPDATE FAILURE OR a MODEL/FUNCTIONALITY UPDATE REJECT message and appropriate cause value (e.g. Update is not allowed, Update is not supported, Model/Functionality update not supported, or any other suitable naming). FIG. 6 shows an example of a new model/functionality update failure procedure.

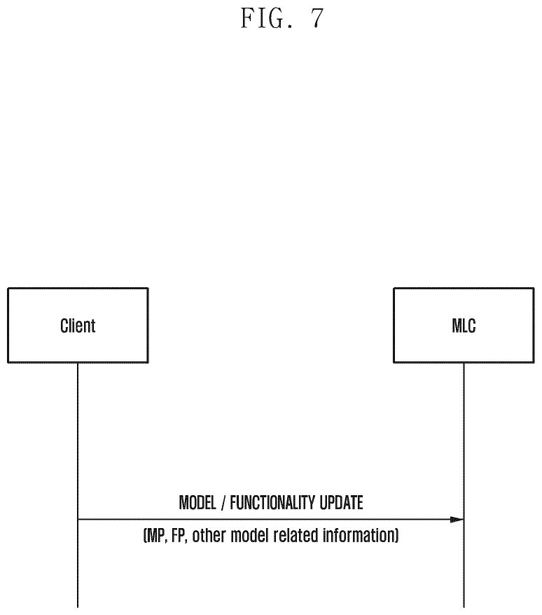

In alternative example, the model update procedure may be defined as a new class 2 procedure, using new and/or existing messages and/or IEs, or defined using existing class 2 procedures, using new and/or existing messages and/or TEs. In an example, the model update procedure may be triggered based on a client request and/or other assistance information from the network. FIG. 7 shows an example of a new model/functionality update Class 2 procedure.

In an example, the MLC, following reception of MODEL/FUNCTIONALITY UDPATE message, from the Client, may update the model and/or functionality, based on information included in the MODEL/FUNCTIONALITY UPDATE message, for example, MP(s), FP(s), other model related information, and/or other assistance information provided by the network.

In an example, the MLC may ignore the request for model update, if the model update information is missing or not appropriate (e.g. does not meet a pre-defined conditions or criteria). Optionally, the MLC may or may not inform the client of ignoring model update request.

In another example, the MLC may initiate the Model update procedure towards the Client, or group of Clients that are involved in this model. In an example, all signalling/messaging defined in above and following examples may be re-used with suitable modification of naming and signalling direction.

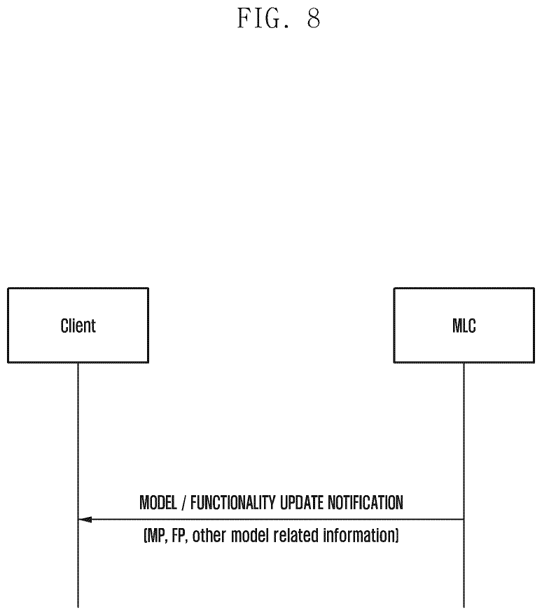

In another example, the MLC notify the Client or group of Client involved in a model, that this model was modified, e.g. by a Client(s), involved with this model and/or the MLC, as shown in FIG. 8. Optionally, following this model/functionality update notification, each Client may trigger Model update procedure, shown in FIGS. 5, 6, and 7.

In an alternative example, the MLC may trigger the model update procedure using a new procedure (class 1 or class 2). FIG. 8 shows an example of a new model/functionality update notification procedure (class 2).

In an example, all Model update procedures/signalling/message exchange, between the client and the MLC, described above, may be assigned a (unique) procedure ID, for example, by the entity (e.g. Client and/or MLC) triggering procedure/signalling/message.

In another example, the MLP or Client may subscribe to any changes/updates of a given model, list of models, functionality and/or list of functionalities and/or any other modification/update in model(s) and/or functionality (ies) at the Client or MLP. In turn the entity (Client or MLP) that receives the subscription message for model and/or functionality modification/change/update will inform the other entity (MLP or Client) of any changes/modification/updates to the model(s) and/or functionality(ies).

In another example, the Client (or the MLC) request model update or model modification, by sending, for example, MODEL MODIFY INDICATION message (or FUNCTIONALTY MODIFY INDICATION message) to the MLC (or the Client(s)). Upon reception of the MODEL MODIFY INDICATION message, the MLC (or the Client(s)), for each model (part of model, or functionality) indicated in this message, update the indicated model (part of model, or functionality) based on model and/or functionality information included in the MODEL MODIFY INDICATION message. In an example, MODEL MODIFY INDICATION message, may include a list of model (and/or functionalities) that are to be updated or modified, e.g. Model Modify List IE, Functionality Modify List IE, or a combined list of models and functionalities. Optionally, the list(s) may include other model and/or functionality related information (e.g. MP(s), FP(s), other).

The MLC (or the Client(s)) reports to the Client(s) in MODEL MODIFY CONFIRM message (or FUNCTIONALTY MODIFY CONFIRM message) the result of modification for each model (part of model, and/or functionality) listed in MODEL MODIFY INDICATION message:
For each model and/or functionality which is successfully modified, the Model Modify Confirm List IE (or Functionality Modify Confirm List IE) may be included containing:
1. The list of Models and Functionalities which have been successfully modified.
2. The list of Models and Functionalities which have failed to be modified.

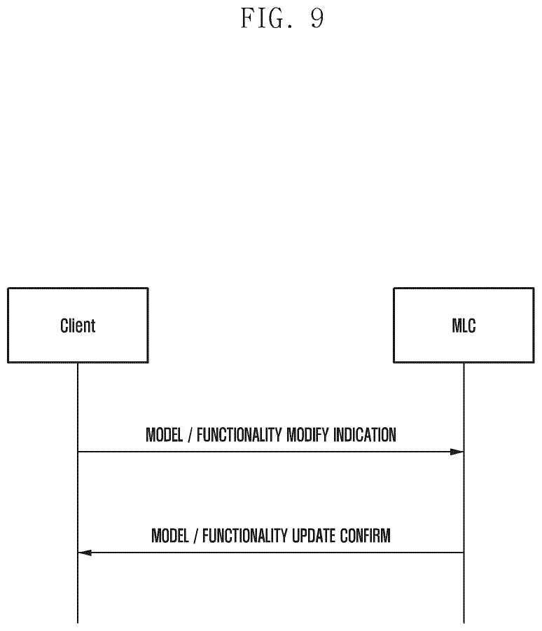

FIG. 9 shows an example of a new MODEL/FUNCTIONALITY MODIFY procedure.

Note that other steps, sub-steps, or combined steps are also possible as part of the above example on Model Update, but not shown/described above for simplicity.

### Model Selection

Step 1: The Client triggers a model selection process by sending a model (or functionality) selection request to MLC (e.g. MODEL/FUNCTIONALITY SELECTION REQUEST message). This request may include information related to model and/or model functionality/use-case/scenario/configuration. For example:

Model description (list of model functionalities (e.g. Functionality ID, Functionality Type), other information).

Model selection conditions/criteria (e.g. List of Functionalities (e.g. Functionality ID, Functionality Type=Mobility Optimization, other) and Model Validation/Evaluation Criteria (e.g. Evaluation Criteria>95%), model size, model format, model training-type (offline or online, or other), model training/inference side, model deployment-type (i.e. one-sided or two-sided).

Other assistance information from the network related to model selection (e.g. pre-configured information, based on PLMN rules, operator rules, country regulations, and/or client subscription information) and/or information from interaction with NWDAF.

List of MP(s), FP(s), and/or other model related information.

In an example, the model (or functionality) selection request may include pre-defined Aggregate Function(s). The aggregate function performs a calculation on a set of MP(s) (and/or FP(s)) that fulfil the selection information in the model selection request. For example:
Best Evaluation Function: return the MP (and/or FP) that has the best Evaluation Criteria.
Average Function: averaging all the model weights of MP(s) (and/or FP(s)) and return an average model. For example, MP(s) and/or FP(s) received from several Clients in the network.
Neighbour Selection Function: return the MP(s) (and/or FP(s)) of the cell neighbours only.
Limit number of MPs (and/or FPs) returned to the Client. For example, define and use a maximum number on MPs (and/or FPs) returned to the Client, and/or information related to the aggregated MPs (and of FPs).
Other actions related to models and/or functionalities aggregation process.
Step 2: The MLC sends to the client, if available, the selected MP(s) (and/or FP(s)) that fulfil the selection information in the model selection request.
For example, the selected MP(s) (and/or FP(s)) could be included in a new message MODEL/FUNCTIONALITY SELECTION RESPONSE or MODEL/FUNCTIONALITY SELECTION REQUEST ACKNOWLEDGE.
   For example, the MLC may also send the following information (e.g. in new or existing IE):
   The MP(s) and/or FP(s) (and/or any other information related to selected model/model functionality) that has the best validation value (i.e. based on Validation Criteria).
   In an example, the MLC may aggregate two or more models that fulfil the model selection conditions/criteria and send to the aggregated model to the Client.
   In an alternative example, the MLC may send a list of all models, part of the models, or aggregate model to the Client. Optionally, the MLC may send the criteria used for model aggregation and/or model ID(s) for aggregated models. Additionally, the MLC may send information (e.g. list of models, model ID(s)) on models that was not aggregated and/or not selected (e.g. failed the selection process). In an example, the MLC may include the reason for model selection failure (e.g. Model ID X, Validation Criteria <95%).

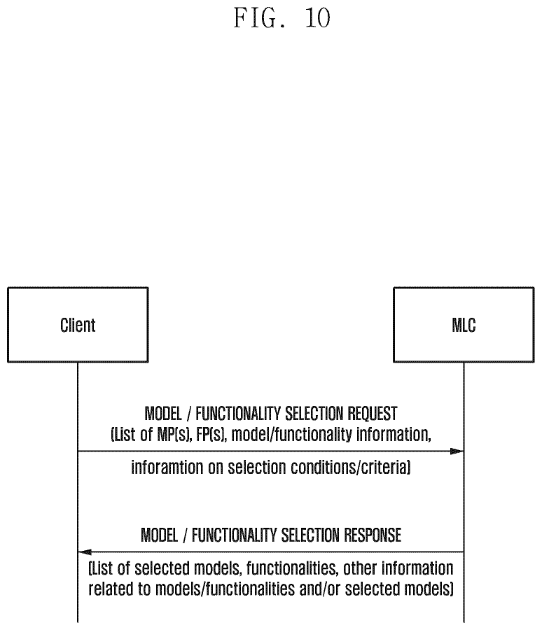

FIG. 10 shows an example of a new model/functionality selection procedure (successful operation).

In an example, the MLC may not accept the model (or functionality) selection request and may respond, for example, with a MODEL/FUNCTIONALITY SELECTION FAILURE or MODEL/FUNCTIONALITY SELECTION REJECT message and appropriate cause value (e.g. selection is not allowed, selection is not supported, model selection not supported, functionality selection not supported, or any other suitable naming).

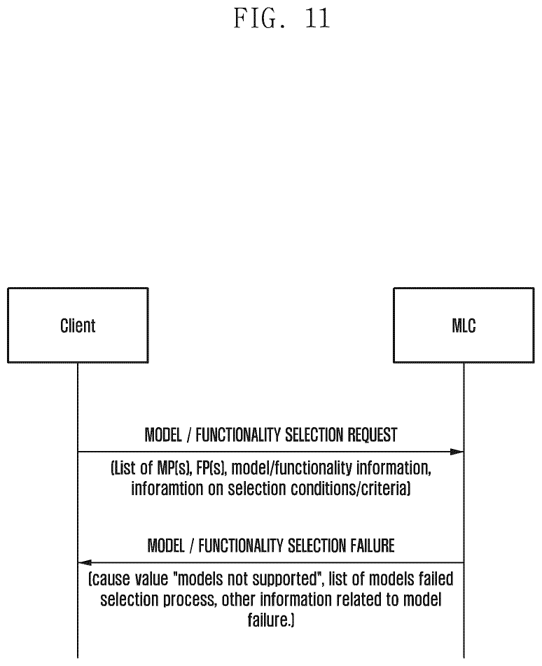

FIG. 11 shows an example of a new model/functionality selection procedure (unsuccessful operation).

In alternative example, the model/functionality selection procedure maybe defined as a new class 2 procedure, using new and/or existing messages and/or IEs, or defined using existing class 2 procedures, using new and/or existing messages and/or IEs. In an example, the model/functionality selection procedure maybe triggered based on a client request and/or other assistance information from the network.

In another example, the MLC may trigger the model and/or functionality selection request at the Client side. For example, the Client has multiple models for a given functionality or multiple functionalities, and the MLC may request selection of a given model for usage with a given functionality or more than one functionality. Optionally, the MLC may include in the selection request, information on model(s) and/or functionality(ies) that the MLC require the Client to select.

In another example, the MLC may also include in the selection request instruction for the Client to process the selected model and/or functionality (e.g. activate, deactivate, switch, other model and/or functionality LCM procedures). Optionally, the MLC may include, if available, in the selection request, information related to the MP(s) and/or FP(s) of the model(s) and/or functionality to be selected and processed at the Client.

In another example, the MLC may send the selection request independently to the model processing request to the client. That is, the MLC may send the model/functionality selection request and model/functionality processing request messages, separately in the same or different procedures. Additionally, the request messages may be sent in parallel or sequentially (e.g. step 1: model/functionality selection request, step 2: process model/functionality request).

In another example, the Client, following reception of model selection request from the MLC, may select the model and/or functionality, based on information included in the model (or functionality) selection message, for example, list of MP(s), FP(s), other model related information, and/or other assistance information provided by the network.

In an example, the MLC (or Client) may ignore the model/functionality selection request, if the model/functionality selection information is missing, incomplete, or not appropriate (e.g. does not meet a pre-defined conditions or criteria). Optionally, the MLC (or Client) may or may not inform the client (or MLC) of ignoring (or cause for ignoring a model/functionality) selection request.

Note that other steps, sub-steps, or combined steps are also possible as part of the above example on Model Selection, but not shown/described above for simplicity.

### Model Subscription

Step 1: The Client triggers a model subscription process by sending a model (and/or functionality) subscription request to the MLC, for example, MODEL/FUNCTIONALITY SUBSCRIPTION REQUEST message. This request may include information related to one or more of a given model(s) and/or model functionality(ies)/use-case(s)/scenario(s)/configuration(s). For example:
Model description (list of model functionalities (e.g. Functionality ID, Functionality Type), other information), and/or Model ID (local, or global, or temporary ID).
Functionality description or Functionality selection conditions
Model selection conditions/criteria (e.g. List of Functionalities (e.g. Functionality ID, Functionality Type=Mobility Optimization, other) and Model Validation/Evaluation Criteria (e.g. Evaluation Criteria>95%), model size, model format, model training-type (offline or online, or other), model training/inference side, model deployment-type (i.e. one-sided or two-sided).
Step 2: The MLC creates an event trigger for the selected MP(s) (and/or FP(s)) that fulfil the subscription information in the model (and/or functionality) subscription request.

For example, the selected MP(s) (and/or FP(s)) could be included in a new message MODEL/FUNCTIONALITY SUBSCRIPTION RESPONSE or MODEL/FUNCTIONALITY SUBSCRIPTION REQUEST ACKNOWLEDGE.
Step 3: The MLC monitors any change in the subscribed MP(s) (and/or FP(s)) and send the changes to the Client.

In an example, the MLC may not accept the model and/or functionality subscription request, and may respond, for example, with a MODEL/FUNCTIONALITY SUBSCRIPTION FAILURE or MODEL/FUNCTIONALITY SUBSCRIPTION REJECT message and an appropriate cause value (e.g. subscription is not allowed, subscription is not supported, Model/Functionality subscription not supported, or any other suitable naming).

### Model Configuration

Step 1: The client triggers the model (and/or functionality) configuration procedure for an AI/ML model for given/specific functionality(s) (or use case(s)/scenario(s)/configuration(s)/site(s)) by sending a model configuration request message (e.g. MODEL/FUNCTIONALITY CONFIGURATION REQUEST message, including information related to model (and/or functionality) configuration.

For example: one or more of model ID (local ID or global ID or temporary ID) and/or functionality ID (local or global ID or temporary ID), model size (e.g. number of layers/number of parameter), model inputs (e.g. input dimension), model output (e.g. output dimension), scenario, other parameters
Step 2: the MLC identifies the model (and/or model functionality/functionalities) by using the received Model ID (and/or Functionality ID), or other information related to the configuration of the model and/or functionality, and configures the model (and/or functionality) based on configuration parameters in the request message.

In one example, the MLC may configure the model for a given functionality or multiple functionalities. In another example, the MLC may configure the functionality for a given model or multiple models.
Step 3: The MLC may reply to client, for example, by sending a MODEL/FUNCTIONALITY CONFIGURATION RESPONSE message or MODEL/FUNCTIONALITY CONFIGURATION ACKNOWLEDGE message to acknowledge that it has successfully configured the model and/or functionality.

In an example, the MLC may not accept the model and/or functionality configuration request, and may respond, for example, with a MODEL/FUNCTIONALITY CONFIGURATION FAILURE or MODEL/FUNCTIONALITY CONFIGURATION REJECT message and an appropriate cause value (e.g. configuration is not allowed, configuration is not supported, Model/Functionality configuration not supported, or any other suitable naming).

### Example Procedures

In the following, examples of model LCM procedures described above are provided. However, the implementation of the above-described procedures are not limited to the following examples. For instance, the information including the messages below may vary and may include any of the information detailed in the above-described procedures. Furthermore, the initial message sent/transmitted by the client may be generally termed an AI/ML model management request message and a response (if present) sent/transmitted from the MLC to the client an AI/ML model management response message; however, the messages may be referred to by any suitable label with their content unaffected.

### Model Registration

Step 1: The client sends a request to MLC to register a new AI/ML model in the database. In the request, the client sends some or all information needed to create a Model Profile (e.g. model functionality/use-case/scenario/site/configuration, version number) and/or similarly a Functionality Profile, and/or other information related to the model.
Step 2(a): The MLC assigns a unique Model ID (and/or Functionality ID) for the registered model (and/or model functionality/functionalities) and create a Model Profile and/or Functionality Profile.
Step 2(b): The MLC stores Model Profile (model architecture, weights and metadata) and/or Functionality Profile (e.g. in MLC or MLC database).
Step 3: The MLC sends to the client the unique Model ID (and/or Functionality ID). Optionally, the MLC may include information related to the Model or Model functionality/functionalities.

### Model Update

Step 1(a): The client has a new AI/ML model that it has generated from an AI/ML training session.
Step 1(b): The client updates the Model Profile (and/or Functionality Profile) and/or any other information related to the Model and/or Model functionality/functionalities
Step 2: The client sends to MLC the updated Model Profile (and/or Functionality Profile) and/or any other information related to the Model and/or Model functionality/functionalities.
Step 3(a): The MLC identify the updated model (and/or model functionality/functionalities) by using the received Model ID (and/or Functionality ID).
Step 3(b): The MLC updates/replaces (totally or partially) the existing/stored (e.g. in MLC) Model Profile (and/or Functionality Profile) with the received MP (and/or FP).

### Model Selection

Step 1: The client triggers a model selection process by sending a model selection request to MLC. This request may include information on selection conditions (or criteria) and/or an Aggregation Function. The Aggregation Function performs a calculation on multiple Model Profiles (or Functionality Profiles) that fulfil the model/functionality selection conditions/criteria.

### Example of Selection Conditions:

Functionality=Mobility Optimization
Location=[Cell 1, Cell 2, . . . ]
Model Validation/Evaluation >95%
Accuracy/metrics/intermediate KPIs

### Example of Aggregate Functions:

Select the Model Profile with highest validation value
Averaging all the models weights
Step 2: The MLC sends to the client the output of Aggregate Functions. That is, the MLC forwards the MP (and/or FP) and/or any other information related to the selected model and/or model functionality/functionalities.

### Model Subscription

Step 1: The client sends a request to the MLC with a subscription condition/criteria.
Example of Subscription Conditions:
   Functionality=Mobility Optimization
   Functionality ID=some unique ID (or description or information associated with functionality)
   Model ID=some unique ID
   Created by=[Cell ID 4, Cell ID 10]
Step 2: The MLC monitors the Model(s) Profiles (and/or Functionality(ies) Profiles), that fulfil the subscription condition, for any change(s) in the database and send/indicate this change to the Client.

### Model Configuration

Step 1: The client sends a request to the MLC with a configuration request condition/criteria.

### Example of Configuration Request:

Model ID=12345
Model Size=3 Layers
Scenario=Urban
Model Input Size=4
Model Output Size=1

Similar example/parameters may also be provided for Functionality Configuration Request.
Step 2: The MLC configures the model (Model ID 12345) and send the configured model to the Client.

In the above examples (i.e. AI/ML Model Learning Transfer Solution), it will be appreciated that one or more of the described steps or states may be modified (e.g., two or more steps or states may be combined), omitted (e.g., one or more of the steps or states may not be included) or moved (e.g., the one or more steps, or a combination thereof, may be provided in a different order), in other examples related to this solution, if desired and appropriate, as would be understood by the skilled person. Additionally, it will be appreciated that additional steps or states may be added, or additional actions/operations performed in each described step or state.

### Example of AI/ML Model Profile (MP) or Functionality Profile (FP):

In addition to the model and/or functionality information discussed above, the following are example contents of the proposed Model Profile (MP) or Functionary Profile (FP) that may be stored in the MLC and/or Client.
Model ID (e.g. local ID or global ID, temporary ID, or (unique) ID in a cell, area, country, or across the network)
Model Version (e.g. v1.5)
Functionality (or use-case/scenario/site/configuration-specific) ID (e.g. local ID or global ID, temporary ID, or (unique) ID across the network)
Functionality (or use-case/scenario) (e.g. Mobility Optimization/Energy saving/Load Balancing)
Model Architecture (e.g. 3 dense layer of ANN)
Model Weights (e.g. w1=0.2, . . . w100=0)
Model Type (e.g. Low Speed UEs)
Model Validation/Evaluation (e.g. 97%)
Model Validation/Evaluation Metric (e.g. Accuracy/Reward/Precision/Recall/F1)
Model Validation/Evaluation Type (e.g. System Performance/Inference)
Training Session/procedure ID(s)
Selection Session/procedure ID(s)
Registration Session/procedure ID(s)
Configuration Session/procedure ID(s)
Subscription Session/procedure ID(s)
Update Session/procedure ID(s)
Other LCM Session/procedure ID(s)
UE Type (e.g. Vehicular, NTN, IoT, UAV, other)
UE Spatial-temporal (e.g. Indoor, Outdoor, Evening, Week, month, year)
UE RRC State (e.g. Idle/Inactive/Connected)
UE Use Case (e.g. High Traffic Load)
UE Service (e.g. Video Streaming)
Updated Time (e.g. date)
Updated Location (e.g. Cell ID, location coordinates, . . . )
Subscriber List (e.g. Cell ID, UE ID, entity IP(s) address . . . )
List of Cells (e.g. serving and/or neighbour cells where model/functionality is available)
List of Clients (e.g. using the model, part of the training session, other)
Created at (e.g. date)
Created by (e.g. NW entities ID or UEs ID or Cell ID, . . . )
Other Information

Note that Functionality Profile (FP) may contain all, part of, similar or modified information to that included in the example above for the MP case.

Certain examples of the present disclosure may be provided in the form of an apparatus/device/network entity configured to perform one or more defined network functions and/or a method therefor. Certain examples of the present disclosure may be provided in the form of a system (e.g. network or wireless communication system) comprising one or more such apparatuses/devices/network entities, and/or a method therefor.

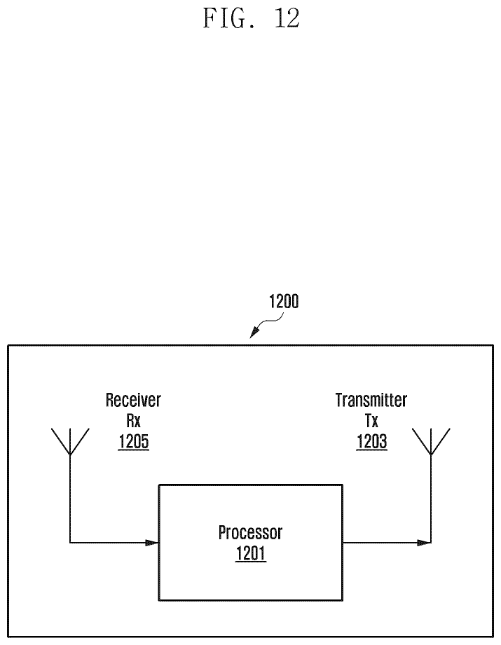

FIG. 12 is a block diagram of an exemplary entity that may be used in examples of the present disclosure, where the entity may be a network entity or an entity external to the network. For example, the client, AI/ML coordinating entity, and MLC of the examples of FIGS. 2-11 may comprise an entity of FIG. 12. The skilled person will appreciate that an entity may be implemented, for example, as a network element on a dedicated hardware, as a software instance running on a dedicated hardware, and/or as a virtualised function instantiated on an appropriate platform, e.g. on a cloud infrastructure. The functionality of the entity may also be distributed.

The entity 1200 comprises a processor (or controller) 1201, a transmitter 1203 and a receiver 1205. The receiver 1205 is configured for receiving one or more messages from one or more other network entities, for example as described above. The transmitter 1203 is configured for transmitting one or more messages to one or more other network entities, for example as described above. The processor 1201 is configured for performing one or more operations, for example according to the operations as described above.

Further examples based on the procedures, messages and/or entities discussed above are set out below.

In an example, a method for managing Artificial Intelligence/Machine Learning (AI/ML) models in a wireless communications network comprising a client entity and an AI/ML coordinating entity is provided, the method comprising: transmitting from the client entity to the AI/ML coordinating entity an AI/ML model management request message; and receiving and processing at the AI/ML coordinating entity the AI/ML model management request message.

In an example, the AI/ML model management request message is an AI/ML model registration request message.

In an example, the AI/ML model registration request message includes parameters of an AI/ML model to be registered, and the processing comprises registering the AI/ML model by assigning an ID to the AI/ML model and storing the AI/ML model in an AI/ML model database.

In an example, storing the AI/ML model comprises storing the parameters of the AI/ML model in an AI/ML model template.

In an example, the method further comprises transmitting from the AI/ML coordinating entity to the client, an AI/ML model management response message indicating successful registration of the AI/ML model or unsuccessful registration of the AI/ML model.

In an example, the AI/ML model management response message indicating a successful registration of the AI/ML model includes information on the registered AI/ML model.

In an example, the AI/ML model management request message is an AI/ML model update request message.

In an example, the AI/ML model update request message includes AI/ML model identification information and updated AI/ML model parameters, and the processing comprises updating a stored AI/ML model identified by the AI/ML identification information based updated AI/ML model parameters.

In an example, the method further comprises transmitting from the AI/ML coordinating entity to the client an AI/ML model management response message indicating a successful updating of the stored AI/ML model, successful updating of parts of the stored AI/ML model, or a failure to update the stored AI/ML model.

In an example, the AI/ML model management request message is an AI/ML model selection request message.

In an example, the AI/ML model selection request message includes AI/ML model selection information including information on one or more of an AI/ML model description, AI/ML model functionality, and AI/ML model selection criteria, and the processing comprises selecting an AI/ML model based on the AI/ML model selection information.

In an example, the method further comprises transmitting from the AI/ML coordinating entity to the client an AI/ML model management response message indicating the selected AI/ML model or that AI/ML model selection has failed.

In an example, the AI/ML model management request message is an AI/ML model subscription request message.

In an example, the AI/ML model subscription request message includes AL/ML model subscription information including one or more of AI/ML model identification information, AI/ML model functionality information, and AI/ML model selection criteria, and the processing comprises identifying an AI/ML model based on the AI/ML model subscription information and monitoring the identified AI/ML model for changes, and the method further comprises, in response to a change in the identified AI/ML model, transmitting from the AI/ML coordinating entity to the client an AI/ML model change notification message indicating the change in the identified AI/ML model.

In an example, the method further comprises transmitting from the AI/ML coordinating entity to the client an AI/ML model management response message indicating a success of subscription request if the subscription request is implemented or failure of the subscription request if the subscription request cannot be implemented.

In an example, the AI/ML model management request message is an AI/ML model configuration request message.

In an example, the AI/ML model configuration request message includes AI/ML model identification information and AI/ML model configuration information.

In an example, the processing includes identifying an AI/ML model based on the AI/ML model identification information and configuring the identified AI/ML model based on the AI/ML model configuration information.

In an example, the method further comprises transmitting from the AI/ML entity to the client an AI/ML model management response message including information on the configured AL/ML model if the configuration is successful, or indicating a failure of the configuration request if the configuration request cannot be implemented.

In an example, the method further comprises transmitting from the AI/ML coordinating entity to the client, an AI/ML model management response message in response to the AI/ML model management request message indicating one or more of an acknowledgment of the AI/ML model management request message, successful processing of the AI/ML model management request message, or unsuccessful processing of the AI/ML model management request message.

In an example, the AI/ML model management request message includes one or more of
an AI/ML model registration request,
an AI/ML model update request,
an AI/ML model selection request,
an AI/ML model subscription request, and
an AI/ML model configuration request.

In an example, the client is any one of a network entity, a user equipment, a server, or an application function of the wireless communications network.

In an example, the AI/ML coordinating entity is any one of or is included in any one of a network entity, a user equipment, a server, an application function, and a model learning controller of the wireless communications network.

In an example, the AI/ML model management request message is based on a 3GPP Next Generation Application Protocol (NGAP) Class 1 or a Class 2 elementary procedure.

In an example, the AI/ML model management request message and the AI/ML model management response message are based on a 3GPP NGAP Class 2 elementary procedure.

In an example, the AI/ML model management request and/or response messages are based on one or more of RRC/NAS, NG, S1, Xn, X2, F1, E1 signalling protocols, system information (periodic and/or on-demand), and/or other type of signalling between any network entity/function and the UE(s).

In an example, the client is a UE or a gNB and the AI/ML coordinating entity is located in the RAN or Core Network (e.g. in an AMF).

In an example, the wireless communications network is a 3GPP compliant 5G or 6G network.

In an example, a method of an Artificial Intelligence/Machine Learning (AI/ML) entity for managing AI/ML models is a wireless communications network comprising a client and the AI/ML coordinating entity is provided, the method comprising:
receiving from the client an AI/ML model management request message; and
processing the AI/ML model management request message,
wherein the AI/ML model management request message includes one or more of an AI/ML model registration request, an AI/ML model update request, an AI/ML model selection request, an AI/ML model subscription request, and an AI/ML model configuration request.

In an example, a network entity of a wireless communications network configured to implement the method of any of the preceding examples is provided.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

Certain examples of the present disclosure provide a computer or processor-readable data carrier having stored thereon a computer program according to any example, aspect, claim or embodiment disclosed herein.

1. A method for artificial intelligence or machine learning (AI/ML) model or functionality life cycle management (LCM) by a management entity in a wireless communication network, the method comprising:
receiving, from a user equipment (UE), a request to register an AI/ML model or functionality, the request including metadata related to the AI/ML model or functionality;
assigning an identifier (ID) to the AI/ML model or functionality; and
storing information on the AI/ML model or functionality and the related metadata.

2. The method of claim 1, wherein the metadata related to the AI/ML model or functionality includes information at least one of a performance indicator, a use-case, a model or functionality input, a model or functionality output, accuracy metrics, a number of layers, a number of parameters, a model or functionality format, a model or functionality scenario, a model or functionality site, version number, model deployment side, model training side, model inference side, model training online or offline, model training type, model size, model format, performance metrics, single or multiple functionality model, or open or proprietary-format model.

3. The method of claim 1, wherein the ID includes at least one of a global model ID, a local model ID, a global functionality ID, or a local functionality ID.

4. The method of claim 1, wherein the stored information on the AI/ML model or functionality includes information at least one of model or functionality ID, model architecture, model weights, validity, registration time, or registration location.

5. The method of claim 1, further comprising:
receiving, from the UE, an update message for the AI/ML model or functionality; and
updating the AI/ML model or functionality based on the update message.

6. The method of claim 1, further comprising:
receiving, from the UE, an AI/ML model or functionality selection request including selection information;
identifying a registered AI/ML model or functionality based on the selection information; and
transmitting, to the UE, an AI/ML model or functionality selection response including information on the identified AI/ML model or functionality.

7. The method of claim 1, wherein the management entity is implemented in at least one of a client entity, a network entity, a network function, a UE, a server, an OAM, or an AF.

8. The method of claim 1, wherein the AI/ML model or functionality LCM is model-based or functionality-based.

9. A management entity for artificial intelligence or machine learning (AI/ML) model or functionality life cycle management (LCM) in a wireless communication network, the management entity comprising:
a transceiver; and
a controller coupled with the transceiver and configured to:
receive, from a user equipment (UE), a request to register an AI/ML model or functionality, the request including metadata related to the AI/ML model or functionality;
assign an identifier (ID) to the AJ/ML model or functionality; and
store information on the AJ/ML model or functionality and the related metadata.

10. The management entity of claim 9,
wherein the metadata related to the AJ/ML model or functionality includes information at least one of a performance indicator, a use-case, a model or functionality input, a model or functionality output, accuracy metrics, a number of layers, a number of parameters, a model or functionality format, a model or functionality scenario, a model or functionality site, version number, model deployment side, model training side, model inference side, model training online or offline, model training type, model size, model format, performance metrics, single or multiple functionality model, or open or proprietary-format model.

11. The management entity of claim 9,
wherein the ID includes at least one of a global model ID, a local model ID, a global functionality ID, or a local functionality ID.

12. The management entity of claim 9,
wherein the stored information on the AI/ML model or functionality includes information at least one of model or functionality ID, model architecture, model weights, validity, registration time, or registration location.

13. The management entity of claim 9,
wherein the controller is further configured to:
receive, from the UE, an update message for the AI/ML model or functionality, and
update the AI/ML model or functionality based on the update message.

14. The management entity of claim 9,
wherein the controller is further configured to:
receive, from the UE, an AI/ML model or functionality selection request including selection information,
identify a registered AI/ML model or functionality based on the selection information, and
transmit, to the UE, an AI/ML model or functionality selection response including information on the identified AI/ML model or functionality.

15. The management entity of claim 9,
wherein the management entity is implemented in at least one of a client entity, a network entity, a network function, a UE, a server, an OAM, or an AF.
